(19) United States
(12) Patent Application Publication
(10) Pub. No.: US 2014/0087071 A1
(43) Pub. Date: Mar. 27, 2014

(54) ION-EXCHANGE MANGANESE OXIDE LITHIUM ADSORBENT USING POROUS STRUCTURE AND METHOD FOR PREPARING THE SAME

(71) Applicant: KOREA INSTITUTE OF GEOSCIENCE AND MINERAL RESOURCES, Daejeon (KR)

(72) Inventors: Kang-Sup Chung, Daejeon (KR); In-Su Park, Daejeon (KR); Hye-Jin Hong, Daejeon (KR); Jung-Ho Ryu, Daejeon (KR); Tae-Gong Ryu, Daejeon (KR); ByounGyu Kim, Daejeon (KR)

(73) Assignee: KOREA INSTITUTE OF GEOSCIENCE AND MINERAL RESOURCES, Daejeon (KR)

(21) Appl. No.: 13/873,512

(22) Filed: Apr. 30, 2013

(30) Foreign Application Priority Data
Sep. 24, 2012 (KR) 10-2012-0105645

(51) Int. Cl. B01J 39/00

(52) U.S. Cl. CPC B01J 39/00
USPC 427/243

(57) ABSTRACT

The present invention relates to an ion-exchange manganese oxide lithium adsorbent using a porous structure and a method for preparing the same. The lithium adsorbent according to the present invention is highly dispersed on the surface of the porous structure, and thus it has excellent adsorption performance and physical stability and is easy to handle. Moreover, through the porous structure, the contact between a lithium-containing solution and the adsorbent is facilitated to maximize the adsorption capacity, thus making it possible to highly efficiently recover lithium ions from a solution containing a small amount of lithium ions.

### CROSS-REFERENCE TO RELATED PATENT APPLICATION

This application claims the benefit of Korean Patent Application No. 10-2012-0105645, filed on Sep. 24, 2012, in the Korean Intellectual Property Office, the disclosure of which is incorporated herein in its entirety by reference.

### BACKGROUND OF THE INVENTION

1. Field of the Invention

The present invention relates to an ion-exchange manganese oxide lithium adsorbent using a porous structure and a method for preparing the same, which exhibits high selectivity toward lithium adsorption, high adsorption capacity, excellent physical stability, and is easy to handle.

2. Description of the Related Art

Lithium is used in a wide range of fields such as secondary battery materials, refrigerant adsorbents, catalysts, medicines, and various industrial applications (such as ceramics, glass, aluminum electrolytic dissolution, synthetic rubbers), etc. and is one of the important resources that have attracted attention as a nuclear fusion energy resource. In particular, it is expected that the demand for lithium will increase when high-capacity batteries, electric vehicles, etc. are put to practical use. As such, lithium is an important resource that can be used in various fields and its importance increases, but the world's land lithium reserves are only about 1.4 million tons. In order to cope with the limited reserves, extensive research aimed at ensuring lithium resources via various routes has continued to progress, and as part of the research, various studies aimed at efficiently recovering traces of lithium dissolved in aqueous solutions such as seawater, bittern, waste liquors of lithium batteries, etc. have been conducted.

As conventional methods for recovering lithium in aqueous solutions, the electrochemical reduction of lithium ions, the reduction of lithium oxide with magnesium or aluminum metal, etc. have been known. In particular, as methods for recovering traces of lithium (0.17 ppm) dissolved in seawater, a method of selectively adsorbing lithium ions to an adsorbent by ion exchange has attracted attention. That is, this method is to economically enrich lithium ions to a concentration required for production of lithium compounds by an adsorption/desorption process. Accordingly, the main concern of the development of adsorption methods is to develop a high-performance adsorbent and an adsorption/desorption system having high selectivity to lithium ions and excellent adsorption and desorption performance.

Methods of preparing manganese oxide powders having spinel structures by solid state reaction or gel process to develop high-performance adsorbents have been known, and the powders prepared by these methods have been used as cathode materials for lithium secondary batteries (Korean Patent Registration No. 10-0245808, Korean Patent Publication No. 10-2003-0028447, etc), lithium adsorbents, etc. However, the use of lithium adsorbents in the form of powder has difficulties in handling and causes loss of adsorbent, and thus methods of molding the powder are studied. For example, Korean Patent Publication No. 10-2003-0009509 discloses a method for preparing an adsorbent in the form of beads by mixing an adsorbent powder with an alumina powder and agglomerating the mixture using a pore-forming agent such as PVC. However, in the case of the preparation of the adsorbent in the form of beads by the conventional PVC addition, its handling is improved, while the adsorption of lithium is reduced by about 30% or higher compared to the adsorbent in the form of powder. To overcome these problems, there are known various methods related to adsorbents using urethane foam (Korean Patent Publication No. 10-2005-0045793), ceramic filter (Korean Patent Publication No. 10-2008-0045626), narrow woven fabric filter (Korean Patent Registration No. 10-0896053), and hollow fiber membrane filter (Korean Patent Publication No. 10-2008-0045625), and a honeycomb-shaped adsorbent (Korean Patent Publication No. 10-2005-0045792). According to these methods, it is described that it is possible to remedy the drawbacks of the lithium adsorbents in the form of powder and thus obtain lithium adsorbents that are easy to handle and exhibit highly selective adsorption to lithium ions and high adsorption performance. However, even with the above-described adsorbents, the problem still remains that the adsorption efficiency is reduced due to the use of binders and the application of already prepared powder adsorbents.

Since the conventional methods for preparing adsorbents employ pore-forming agents, binders, organic solvents, and powder adsorbents, they exhibit low adsorption performance, cause environmental problems, and increase manufacturing costs, and thus their efficiency and economic feasibility are low. Thus, there is a need to develop a new type of lithium adsorbent and system which exhibits excellent adsorption performance to selectively adsorb only lithium ions and allow the adsorption/desorption process to be easily performed, compared to the lithium adsorbent in the form of powder.

### SUMMARY OF THE INVENTION

The present inventors have studied on a preparation process of a high-performance adsorbent and an adsorption system for recovering a small amount of lithium ions dissolved in natural seawater and found that when a highly-dispersed lithium-manganese oxide adsorbent is prepared using a porous structure, the flow of natural seawater into the porous structure is facilitated to maximize the contact between the seawater and the adsorbent, which maximizes the adsorption recovery efficiency of a small amount of lithium ions contained in natural seawater, thus completing the present invention.

Accordingly, the present invention provides an ion-exchange manganese oxide lithium adsorbent using a porous structures and a method for preparing the same.

### BRIEF DESCRIPTION OF THE DRAWINGS

The above and other features and advantages of the present invention will become more apparent by describing in detail exemplary embodiments thereof with reference to the attached drawings in which:

FIG. 1 shows a glass structure as an example of a porous structure and a lithium-manganese oxide using the same, in which (a) shows the porous glass structure and (b) shows the lithium-manganese oxide using the porous glass structure;

FIG. 2 shows SEM images of a lithium-manganese oxide using a porous glass structure, in which (a) shows the surface, (b) shows the cross section, and (c) shows a highly-dispersed lithium-manganese oxide;

FIG. 3 shows XRD results of a porous glass structure and a lithium-manganese oxide using the same, in which (a) shows the XRD results of the porous glass structure and (b) shows the XRD results of the lithium-manganese oxide using the same;

FIG. 4 shows the amounts of lithium ions adsorbed to a manganese oxide lithium adsorbent using a porous glass structure and an ion-exchange manganese oxide lithium adsorbent in the form of powder.

### DETAILED DESCRIPTION OF THE INVENTION

The present invention provides a manganese oxide lithium adsorbent using a porous structure, represented by the following Chemical Formulas 1 to 4:

[Chemical Formula 1]

LiₙMn₂₋ₓO₄

where 1≦n≦1.33, 0≦x≦0.33, and n≦1+x.

[Chemical Formula 2]

Li_{1.6}Mn_{1.6}O₄

[Chemical Formula 3]

LiₙMn_{2-x-y}M_{y}O₄

where 1≦n≦1.33, 0≦x≦0.33, n≦1+x, 0<y<1.67, and M is a transition metal.

[Chemical Formula 4]

Li_{1.6}Mn_{1.6-y}M_{y}O₄

Where 0<y<1.6 and M is a transition metal.

Moreover, the present invention provides a method for preparing a manganese oxide lithium adsorbent using a porous structure, the method comprising the steps of:
(a) preparing a lithium-manganese mixed solution for impregnation of a porous structure;
(b) impregnating the porous structure in the lithium-manganese mixed solution prepared in step (a) and drying the resulting porous structure;
(c) preparing a lithium-manganese oxide by subjecting the porous structure dried in step (b) to a sintering process; and
(d) preparing a manganese oxide lithium adsorbent by adding the prepared lithium-manganese oxide to an acid solution and reacting the mixture.

Hereinafter, the present invention will be described in detail.

The manganese oxide lithium adsorbent according to the present invention is prepared by impregnating a porous structure in a lithium-manganese mixed solution, drying the resulting porous structure, preparing a lithium-manganese oxide by subjecting the dried porous structure to a sintering process, and adding the resulting lithium-manganese oxide to an acid solution and reacting the mixture such that lithium ions are released.

A method for preparing the manganese oxide lithium adsorbent according to the present invention will be described in detail step by step below.

Step (a) is to prepare a lithium-manganese mixed solution by mixing lithium acetate dihydrate (LiCH₃COO·2H₂O) and manganese acetate tetrahydrate (Mn(CH₃COO)₂·4H₂O). Here, the ratio of Li to Mn is preferably 0.5 to 2.0 (Li/Mn=0.5-2.0), more preferably 0.7 to 1.5 (Li/Mn=0.7-1.5).

Step (b) is to impregnate a porous structure in the lithium-manganese mixed solution prepared in step (a) and drying the resulting porous structure. Here, the concentration of the mixed solution is preferably 0.1 to 4 M, more preferably 1 M.

It is preferable that the porous structure has a porosity of 1 to 500 μm and, in the present invention, it is more preferable that a porous glass structure is used.

It is preferable that the drying is performed at 40 to 100° C. for 2 to 10 hours, more preferably at 80° C. for 3 hours.

Step (c) is to prepare a lithium-manganese oxide by sintering the resulting porous structure dried in step (b) at 300 to 900° C. for 0.1 to 50 hours, preferably 500° C. for 8 hours.

Step (d) is to prepare a manganese oxide lithium adsorbent by adding the lithium-manganese oxide prepared in step (c) to an acid solution and reacting the mixture such that lithium ions are released. Here, it is preferable that the reaction takes place in a 0.01 to 5 M acid solution for 5 to 170 hours, more preferably in an acid solution of 0.3 M for 24 hours.

Examples of the acid solution include, but not limited to, a hydrochloric acid solution, a sulfuric acid solution, a nitric acid solution, etc.

The contact between the resulting manganese oxide lithium adsorbent and a lithium solution, which passes through pores in the porous structure, is maximized, which makes it possible to effectively recover lithium ions from the lithium solution containing a small amount of lithium ions.

Accordingly, the ion-exchange manganese oxide lithium adsorbent according to the present invention can be effectively used as an adsorbent having excellent adsorption performance and physical stability and is easy to handle.

Hereinafter, preferred examples will be presented for a better understanding of the present invention. However, the following examples are provided for illustrative purpose only, and are not to be construed to limit the scope of the present invention.

### EXAMPLE 1

### Preparation of Manganese Oxide Lithium Adsorbent Using Porous Structure

A porous glass structure (with a pore size of 100 to 160μm) was immersed in a mixed solution (Li/Mn=0.7-1.5) of 1 M lithium acetate dihydrate and manganese acetate tetrahydrate for several minutes and then dried at 80° C. for 3 hours. The dried porous glass structure was sintered at 500° C. for 8 hours to form a lithium-manganese oxide on the surface of the porous glass structure. Then, the formed lithium-manganese oxide was added to a 0.3 M hydrochloric acid solution, and the resulting mixture was reacted for 24 hours, thus preparing a manganese oxide lithium adsorbent.

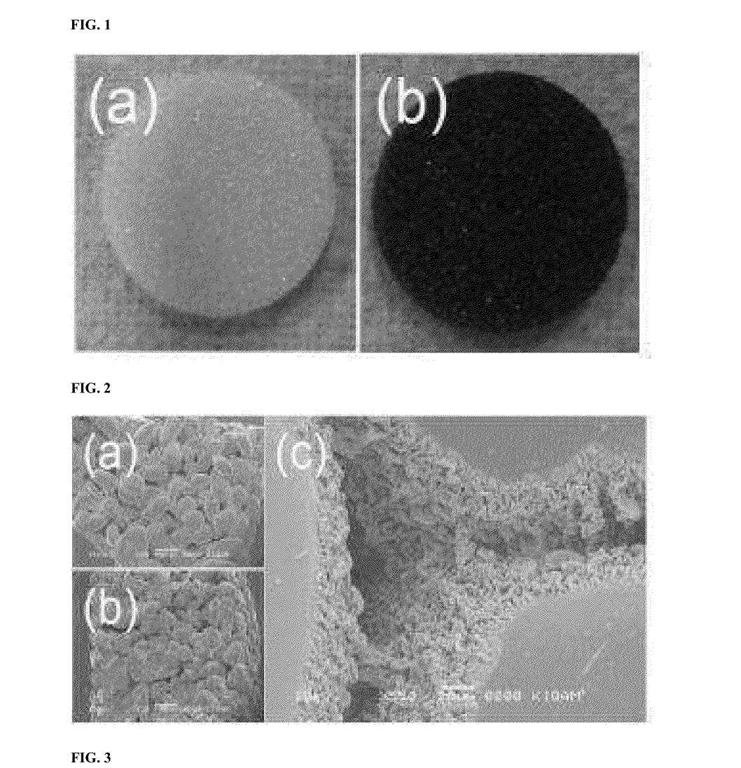

The porous glass structure and the glass structure on which the lithium-manganese oxide is coated are shown in (a) and (b) of FIG. 1, respectively, the SEM analysis results of the lithium-manganese oxide coated on the porous glass structure are shown in FIG. 2, and the XRD analysis results thereof are shown in FIG. 3.

As shown in FIG. 1, it was found that the white transparent glass structure was discolored black after the preparation of the lithium-manganese oxide and uniformly coated.

Moreover, as shown in FIG. 2, as a result of the SEM analysis, it was found that the lithium-manganese oxide was highly dispersed with a thickness of several to several tens of micrometers in the pores of the porous glass structure.

Furthermore, as shown in FIG. 3, as a result of XRD results, it was found that a lithium-manganese oxide with a spinel structure was formed in the pores of the porous glass structure.

### COMPARATIVE EXAMPLE 1

### Preparation of Manganese Oxide Lithium Adsorbent in the Form of Powder

A mixed solution (Li/Mn=0.7-1.5) of 1 M lithium acetate dihydrate and manganese acetate tetrahydrate was used to form a powder by vacuum evaporation at 60 to 80° C., and the powder was sintered at 500° C. for 8 hours, thus preparing a lithium-manganese oxide. Then, the prepared lithium-manganese oxide was added to a 0.3 M hydrochloric acid solution, and the resulting mixture was reacted for 24 hours, thus preparing a manganese oxide lithium adsorbent in the form of powder.

### EXPERIMENTAL EXAMPLE 1

### Analysis of Amounts of Lithium Ions Adsorbed to Manganese Oxide Lithium Adsorbents Using Porous Glass Structure

To analyze the lithium ion adsorption properties of the manganese oxide lithium adsorbent using the porous glass structure in Example 1 and the manganese oxide lithium adsorbent in the form of powder in Comparative Example 1, the following experiment was performed.

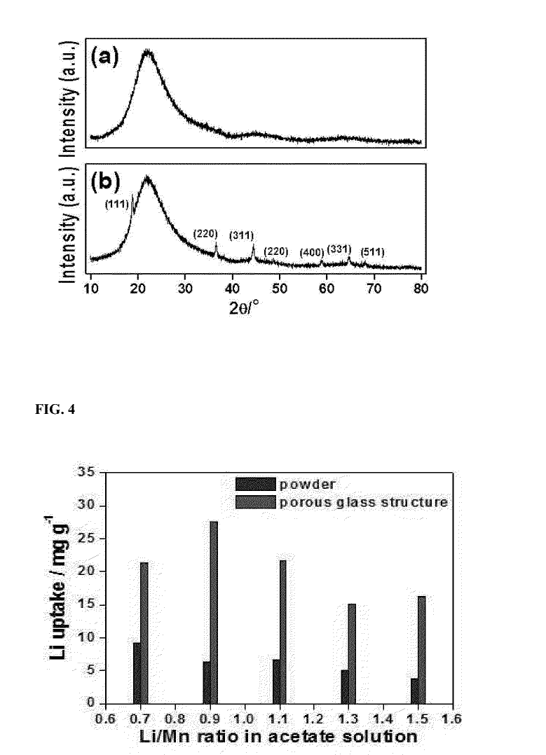

Specifically, a lithium solution in a concentration of 30 ppm was prepared using seawater and added to the manganese oxide lithium adsorbents prepared in Example 1 and Comparative Example 1, and the resulting mixtures were left for 24 hours. Then, the amounts of lithium ions released in a 0.3 M hydrochloric acid solution were analyzed, and the results are shown in FIG. 4.

As shown in FIG. 4, at all Li/Mn ratios applied, the adsorbent using the porous glass structure exhibited the amount of lithium ions adsorbed 2 to 4 times higher than that of the adsorbent in the form of powder.

As described above, the ion-exchange manganese oxide lithium adsorbent according to the present invention is highly dispersed on the surface of the porous structure, and thus it has excellent adsorption performance and physical stability and is easy to handle. Moreover, through the porous structure, the contact between a lithium-containing solution and the adsorbent is facilitated to maximize the adsorption capacity, thus making it possible to highly efficiently recover lithium ions from a solution containing a small amount of lithium ions.

While the invention has been shown and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A method for preparing a manganese oxide lithium adsorbent using a porous structure, the method comprising the steps of:
(a) preparing a lithium-manganese mixed solution;
(b) impregnating a porous glass structure with a pore size of 1 to 500 μm in the lithium-manganese mixed solution prepared in step (a) and drying the resulting porous glass structure;
(c) preparing a lithium-manganese oxide by subjecting the porous glass structure dried in step (b) to a sintering process; and
(d) preparing a manganese oxide lithium adsorbent by adding the prepared lithium-manganese oxide to an acid solution and reacting the mixture.

2. The method of claim 1, wherein in step (a), the mixed solution is prepared by mixing lithium acetate dihydrate (LiCH₃COO·2H₂O) and manganese acetate tetrahydrate (Mn(CH₃COO)₂·4H₂O).

3. The method of claim 1, wherein in step (b), the drying is performed at 40 to 100° C. for 2 to 10 hours.

4. The method of claim 1, wherein in step (c), the sintering process is performed at 300 to 900° C. for 0.1 to 50 hours.

5. The method of claim 1, wherein in step (d), the reaction is performed in a 0.01 to 5 M acid solution for 5 to 170 hours.

6. The method of claim 1, wherein in step (d), the acid solution comprises at least one selected from the group consisting of a hydrochloric acid solution, a sulfuric acid solution, and a nitric acid solution.
